(19) United States
(12) Patent Application Publication
(10) Pub. No.: US 2015/0117421 A1
(43) Pub. Date: Apr. 30, 2015

(54) ADAPTIVE DUAL BAND MIMO WI-FI APPARATUS, AND OPERATING METHOD THEREOF

(71) Applicant: SAMSUNG ELECTRO-MECHANICS CO., LTD., Suwon-Si (KR)

(72) Inventors: Seong Yeon Kim, Suwon-Si (KR); Sun Young Yu, Suwon-Si (KR)

(73) Assignee: SAMSUNG ELECTRO-MECHANICS CO., LTD., Suwon-Si (KR)

(21) Appl. No.: 14/268,395

(22) Filed: May 2, 2014

(30) Foreign Application Priority Data
Oct. 31, 2013 (KR) 10-2013-0131165

(51) Int. Cl. H04W 88/02; H04W 84/12; H04B 7/04

(52) U.S. Cl. CPC H04W 88/02; H04B 7/0413; H04W 84/12
USPC 370/338

(57) ABSTRACT

An adaptive dual band Multiple-Input Multiple-Output (MIMO) wireless-fidelity (Wi-Fi) apparatus may include an application processor, an interface unit transmitting data and a control signal from the application processor, a first dual band wireless communications unit performing wireless communications using at least one of a first band and a second band; a second dual band wireless communications unit performing wireless communications using at least one of the first band and the second band upon being operated, a first selecting unit providing a first path between the first dual band wireless communications unit and a first antenna and providing a second path between the second dual band wireless communications unit and the first antenna, and a second selecting unit providing a first path between the second dual band wireless communications unit and the second antenna and providing a second path between the first dual band wireless communications unit and the second antenna.

### CROSS-REFERENCE TO RELATED APPLICATION

This application claims the benefit of Korean Patent Application No. 10-2013-0131165 filed on Oct. 31, 2013, with the Korean Intellectual Property Office, the disclosure of which is incorporated herein by reference.

### BACKGROUND

The present disclosure relates to an adaptive dual band Multiple-Input Multiple-Output (MIMO) wireless-fidelity (Wi-Fi) apparatus, and an operating method thereof.

A wireless local area network (WLAN) communications apparatus, generally an apparatus wirelessly transmitting data via Internet, or the like, conforming to the IEEE 802.11 or IEEE 802.11x (where x is a, b, g, n) standards, may be manufactured as a separate system or may be provided in a portable apparatus such as a mobile phone.

A WLAN communications apparatus as described above has been recognized as a Wi-Fi apparatus having relatively rapid WLAN transfer rates, as transfer rates have gradually been increased in speed.

The Wi-Fi apparatus described above may use frequency bands that are different from each other. For example, in an initial WLAN communications apparatus conforming to the IEEE 802.11 standard, a 2.4 GHz band, a single band, has been used, and then, following the IEEE 802.11a standard, a 5 GHz band has also been used.

Accordingly, a dual band technology capable of using both the 2.4 GHz band and the 5 GHz band in one Wi-Fi apparatus has been developed.

Meanwhile, in order to implement a Multiple-Input Multiple-Output (MIMO) for increasing a communications transfer rate, since the Wi-Fi apparatus should have a MiMO encoder and a MIMO decoder as well as a plurality of antennas, it has been restrictively used in a system which may have a significant occupied space.

An existing dual band Wi-Fi apparatus may include both a 2.4 GHz wireless communications chip and a 5 GHz wireless communications chip.

In an existing dual band Wi-Fi apparatus as described above, the 2.4 GHz band may be used by operating the 2.4 GHz wireless communications chip or the 5 GHz band may be used by operating the 5 GHz wireless communications chip, depending on a communications environment.

However, since such an existing dual band Wi-Fi apparatuses is used by operating anyone of the 2.4 GHz wireless communications chip and the 5 GHz wireless communications chip, there is a limitation in utilizing two communications chips.

In addition, in the case in which an existing dual band Wi-Fi apparatus is used in a small portal apparatus such as a mobile phone, there are limitations in implementing MIMOs due to limitations on space, such that a large number of antennas may not be installed.

The following Related Art Document related to a dual band frequency wireless local area network does not disclose technical contents efficiently utilizing a dual band or technical contents enabling the MIMO to be implemented even in the small portable apparatus.

### RELATED ART DOCUMENT

Korean Patent Laid-Open Publication No. 2011-0118839

### SUMMARY

Some embodiments of the present disclosure may provide an adaptive dual band MIMO Wi-Fi apparatus capable of efficiently utilizing dual band communications and allowing a MIMO operation to be performed even in a small portable apparatus, and an operating method thereof.

According to some embodiments of the present disclosure, an adaptive dual band Multiple-Input Multiple-Output (MIMO) wireless-fidelity (Wi-Fi) apparatus may include: an application processor controlling wireless communications according to a service mode, determined depending on an communications environment and a state of a connection target communications device; an interface unit transmitting data and a control signal from the application processor; a first dual band wireless communications unit performing wireless communications using at least one of a first band and a second band according to controlling by the application processor; a second dual band wireless communications unit operating of which is determined according to controlling by the application processor, performing wireless communications using at least one of the first band and the second band upon being operated; a first selecting unit providing a first path between the first dual band wireless communications unit and a first antenna and providing a second path between the second dual band wireless communications unit and the first antenna; and a second selecting unit providing a first path between the second dual band wireless communications unit and the second antenna and providing a second path between the first dual band wireless communications unit and the second antenna.

According to some embodiments of the present disclosure, an adaptive dual band Multiple-Input Multiple-Output (MIMO) wireless-fidelity (Wi-Fi) apparatus may include: an application processor controlling wireless communications according to a service mode, determined depending on an communications environment and a state of a connection target communications device; an interface unit transmitting data and a control signal from the application processor; a first dual band wireless communications unit enabled to operate according to controlling by the application processor, operated by being synchronized with one of a rising edge and a falling edge of a preset system clock signal, and performing wireless communications using at least one of the first band and the second band; a second dual band wireless communications unit enabled to operate according to controlling by the application processor, operated by being synchronized with the other of the rising edge and the falling edge of the system clock signal, and performing wireless communications using at least one of the first band and the second band; a first selecting unit providing a first path between the first dual band wireless communications unit and a first antenna and providing a second path between the second dual band wireless communications unit and the first antenna; and a second selecting unit providing a first path between the second dual band wireless communications unit and the second antenna and providing a second path between the first dual band wireless communications unit and the second antenna.

The application processor may include a clock generating unit generating the system clock signal, may be synchronized with one of a rising edge and a falling edge of the system clock signal to control the first dual band wireless communications unit, and may be synchronized with the other of the rising edge and the falling edge of the system clock signal to control the second dual band wireless communications unit.

The first selecting unit may include a diplexer low-passing a first band signal between the first dual band wireless communications unit and the first antenna and high-passing a second band signal between the second dual band wireless communications unit and the first antenna.

The second selecting unit may include a diplexer low-passing a first band signal between the second dual band wireless communications unit and the second antenna and high-passing a second band signal between the first dual band wireless communications unit and the second antenna.

The first dual band wireless communications unit may include: a first media access control (MAC) layer unit processing transmission and reception data frames; a first physical layer unit connected to the first MAC layer unit and including a first band physical layer unit processing modulation and demodulation, coding, and decoding for transmission and reception data for the first band and a second band physical layer unit processing modulation and demodulation, coding, and decoding for transmission and reception data for the second band; and a first dual band wireless communications unit including a first band wireless communications unit connected to the first band physical layer unit and performing wireless transmissions and reception through the first band and a second band wireless communications unit connected to the second band physical layer unit and performing wireless transmissions and reception through the second band.

The second dual band wireless communications unit may include: a second media access control (MAC) layer unit processing transmission and reception data frames; a second physical layer unit connected to the second MAC layer unit and including a first band physical layer unit processing modulation and demodulation, coding, and decoding for transmission and reception data for the first band and a second band physical layer unit processing modulation and demodulation, coding, and decoding for transmission and reception data for the second band; and a second dual band wireless communications unit including a first band wireless communications unit connected to the first band physical layer unit and performing wireless transmissions and reception through the first band and a second band wireless communications unit connected to the second band physical layer unit and performing wireless transmissions and reception through the second band.

According to some embodiments of the present disclosure, an operating method of an adaptive dual band Multiple-Input Multiple-Output (MIMO) wireless-fidelity (Wi-Fi) apparatus may include: collecting, by an application processor, information on surrounding communications device states for communication and a communications environment through a first dual band wireless communications unit; determining, by the application processor, whether or not a concurrent connection to two communications devices is possible based on the collected information; determining whether or not a dual band connection of a connection target communications device is possible when the concurrent connection to the two communications devices is possible; determining whether or not a MIMO operation of the connection target communications device is possible when the concurrent connection to the two communications devices is not possible or the dual band connection of the connection target communications device is not possible; and performing, by the application processor, communications in one of a single mode, a dual mode, and a MIMO mode using at least one of the first and second dual band wireless communications units by sharing channel information with the connection target communications device according the determination result.

According to some embodiments of the present disclosure, an operating method of an adaptive dual band Multiple-Input Multiple-Output (MIMO) wireless-fidelity (Wi-Fi) apparatus may include: collecting, by an application processor, information on surrounding communications device states for communication and a communications environment through a first dual band wireless communications unit; determining, by the application processor, whether or not a concurrent connection to two communications devices is possible based on the collected information; determining whether or not a dual band connection of a connection target communications device is possible when the concurrent connection to the two communications devices is possible; determining whether or not a MIMO operation of the connection target communications device is possible when the concurrent connection to the two communications devices is not possible or the dual band connection of the connection target communications device is not possible; and performing, by the application processor, communications in one of a single mode, a dual mode, and a MIMO mode using at least one of the first and second dual band wireless communications units by sharing channel information with the connection target communications device according the determination result, wherein when the application processor performs the communications in the dual mode, the first and second dual band wireless communications units are operated by being synchronized with different edges of a rising edge and a falling edge of a preset system clock signal.

In the performing of the communications, when the MIMO operation of the connection target communications device is not possible in the determining of whether or not the MIMO operation is possible, the communications may be performed in the single mode using one of first and second bands through the first dual band wireless communications unit.

In the performing of the communications, when the MIMO operation of the connection target communications device is possible in the determining of whether or not the MIMO operation is possible, the communications may be performed by using the MIMO operation using one of first and second bands through the first and second dual band wireless communications units.

In the performing of the communications, when the dual band connection of the connection target communications device is possible in the determining of whether or not the dual band connection of the connection target communications device is possible, the communications may be performed by using first and second bands through the first and second dual band wireless communications units.

In the performing of the communications, one of a 2.4 GHz band and a 5 GHz band, supported by the first dual band wireless communications unit, and one of the 2.4 GHz band and the 5 GHz band, supported by the second dual band wireless communications unit may be used.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram of an adaptive dual band MIMO Wi-Fi apparatus according to an exemplary embodiment of the present disclosure;

FIG. 2 is a diagram illustrating an example of implementation of an application processor according to an exemplary embodiment of the present disclosure;

FIG. 3 is an operation timing chart of a system clock signal and first and second dual band wireless communications units according to an exemplary embodiment of the present disclosure;

FIG. 4 is an internal block diagram of the first and second dual band wireless communications units according to an exemplary embodiment of the present disclosure;

FIG. 5 is a first diagram of a single mode operation of the first dual band wireless communications unit according to an exemplary embodiment of the present disclosure;

FIG. 6 is a second diagram of a single mode operation of the first dual band wireless communications unit according to an exemplary embodiment of the present disclosure;

FIG. 7 is a first diagram of a MIMO operation of the first and second dual band wireless communications units according to an exemplary embodiment of the present disclosure;

FIG. 8 is a second diagram of a MIMO operation of the first and second dual band wireless communications units according to an exemplary embodiment of the present disclosure;

FIG. 9 is an diagram of a dual band mode operation of the first and second dual band wireless communications units according to an exemplary embodiment of the present disclosure; and

FIG. 10 is a flow chart showing an operating method of an adaptive dual band MIMO Wi-Fi apparatus according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

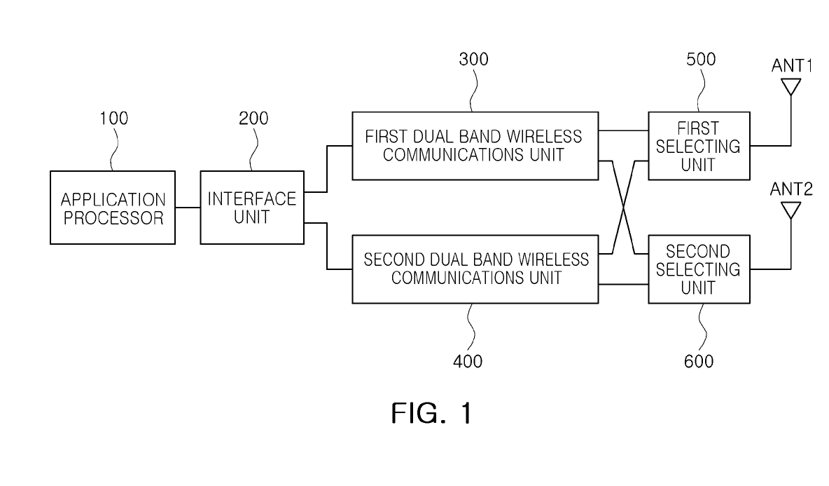

FIG. 1 is a block diagram of an adaptive dual band MIMO Wi-Fi apparatus according to an exemplary embodiment of the present disclosure.

Referring to FIG. 1, an adaptive dual band MIMO Wi-Fi apparatus may include an application processor 100, an interface unit 200, a first dual band wireless communications unit 300, a second dual band wireless communications unit 400, a first selecting unit 500, and a second selecting unit 600.

The application processor 100 may control wireless communications according to a service mode, determined depending on a communications environment and a state of a target communications device.

For example, the application processor 100 may collect information on the communications environment and the state of the target communications device using the first dual band wireless communications unit 300. Here, the communications environment may include quality of service information and channel state information for each frequency channel.

In this case, when dividing the wireless environment by each piece of quality of service (QoS) information, the wireless environment may be divided into voice, video, Internet or best effort, data transfer, background, or the like (see 802.11e MAC). For example, a service that a user wants to use is requested through a wireless communications apparatus (e.g., a Wi-Fi apparatus or a terminal), the quality of service (QoS) information may be obtained through an action of an infra structure mode AP or a Wi-Fi direct (peer-to-peer mode) terminal in response to the request.

In addition, with respect to the channel state, a state of an air interface may or may not become a situation, suitable for communications in the wireless communications environment. In the case in which the communications are inevitably performed in spite of a bad channel state, since transmission and reception efficiency may be decreased in light of the entire system, a terminal suitable for the channel state may be selected in view of efficiency.

In addition, the state of the target communications device may include information about whether or not the target communications device supports the dual band mode, the MIMO mode, or the like.

For example, when the terminal may use only the 2.4 GHz band or the 5 GHz band, the terminal needs to be operated in a single band mode because it may not use the dual band mode. Unlike this, when the terminal may support both the 2.4 GHz band and the 5 GHz band, the terminal is a terminal capable of being operated in the dual band mode. Here, when a typical Wi-Fi apparatus transmits a beacon signal using the 2.4 GHz band and the 5 GHz band, preset by an access point, the terminal may recognize the beacon signal. Alternatively, the typical Wi-Fi apparatus may detect whether the terminal may be operated as surrounding access points or the terminal may be operated in the dual band mode by an active scan.

Next, the application processor 100 may control wireless communications using the first dual band wireless communications unit 300 and the second dual band wireless communications unit 400 according to a service mode determined depending on the communications environment and the state of the connection target communications device.

Here, one of the 2.4 GHz band and the 5 GHz band, supported by the first dual band wireless communications unit 300, and one of the 2.4 GHz band and the 5 GHz band, supported by the second dual band wireless communications unit 400 may be used. In addition, the connection target communications device may be a wireless Wi-Fi apparatus such as an access point, or the like, or a mobile device such as a smart phone, or the like.

The interface unit 200 may transmit data and a control signal from the application processor 100 to the first dual band wireless communications unit 300 and the second dual band wireless communications unit 400 and may transmit data from the first dual band wireless communications unit 300 and the second dual band wireless communications unit 400, respectively, to the application processor 100.

The first dual band wireless communications unit 300 may perform wireless communications using at least one of the first band and the second band according to controlling by the application processor 100.

Whether or not the second dual band wireless communications unit 400 is operated may be determined according to controlling by the application processor 100 and when the second dual band wireless communications unit 400 is operated, the second dual band wireless communications unit 400 may perform wireless communications using at least one of the first band and the second band.

Here, one of the first dual band wireless communications unit 300 and the second dual band wireless communications unit 400 is given with priority as a main IC (a primary main IC) and the other may be set as a sub-IC (a secondary IC).

The first selecting unit 500 may provide a first path between the first dual band wireless communications unit 300 and a first antenna ANT1 and may provide a second path between the second dual band wireless communications unit 400 and the first antenna ANT1.

The second selecting unit 600 may provide a first path between the second dual band wireless communications unit 400 and a second antenna ANT2 and may provide a second path between the first dual band wireless communications unit 300 and the second antenna ANT2.

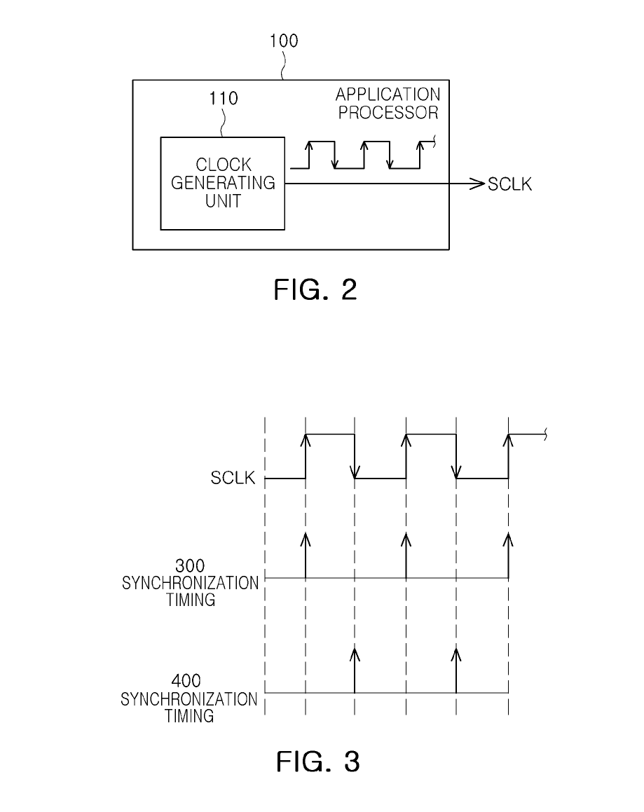

FIG. 2 is a diagram illustrating an example of implementation of an application processor according to an exemplary embodiment of the present disclosure.

Referring to FIG. 2, the application processor 100 may include a clock generating unit 110 generating a system clock signal (SCLK).

In this case, the application processor 100 may be synchronized with one of a rising edge and a falling edge of the system clock signal (SCLK) to control the first dual band wireless communications unit 300 and may be synchronized with the other of the rising edge and the falling edge of the system clock signal (SCLK) to control the second dual band wireless communications unit 400.

For example, in the case in which the first dual band wireless communications unit 300 is synchronized with the rising edge of the system clock signal (SCLK) to perform signal processing, the second dual band wireless communications unit 400 may be synchronized with the falling edge of the system clock signal (SCLK) to perform signal processing, or vice versa.

As described above, in the case in which the first dual band wireless communications unit 300 is synchronized with the rising edge of the system clock signal (SCLK) to perform signal processing and the second dual band wireless communications unit 400 is synchronized with the falling edge of the system clock signal (SCLK) to perform signal processing, the first and second dual band wireless communications units 300 and 400 may be operated separately and may process a signal at relatively high speed without causing a particular time delay.

FIG. 3 is an operation timing chart of a system clock signal and first and second dual band wireless communications units according to an exemplary embodiment of the present disclosure.

Referring to FIG. 3, as an example, the first dual band wireless communications unit 300 may be synchronized with the rising edge of the system clock signal (SCLK) to perform signal processing and the second dual band wireless communications unit 400 may be synchronized with the falling edge of the system clock signal (SCLK) to perform signal processing.

An illustration described in the present specification is an example for assisting in the understanding of the description. Therefore, the present disclosure is not limited thereto.

Referring to FIG. 1, the first selecting unit 500 and the second selecting unit 600 may be implemented by a diplexer.

In this case, the diplexer, the first selecting unit 500, may low-pass a first band signal between the first dual band wireless communications unit 300 and the first antenna ANT1 and may high-pass a second band signal between the second dual band wireless communications unit 400 and the first antenna ANT1.

In addition, the diplexer, the second selecting unit 600, may low-pass a first band signal between the second dual band wireless communications unit 400 and the second antenna ANT2 and may high-pass a second band signal between the first dual band wireless communications unit 300 and the second antenna ANT2.

With respect to whether or not the first selecting unit 500 is used or the second selecting unit 600 is used, the application processor 100 may use the first and second selecting units 500 and 600 by detecting channel information to select an antenna having a good channel state.

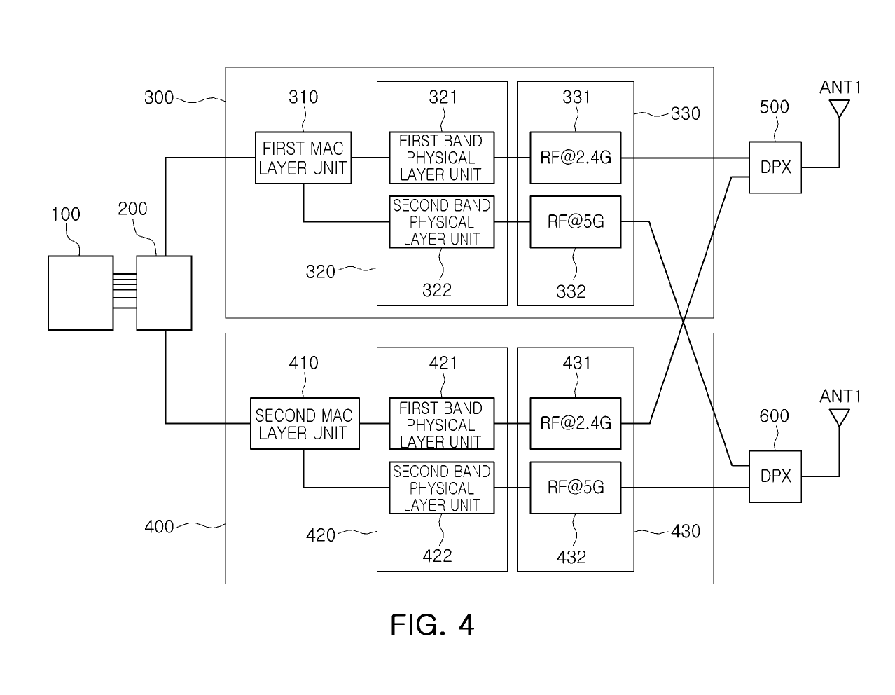

FIG. 4 is an internal block diagram of the first and second dual band wireless communications units according to an exemplary embodiment of the present disclosure.

Referring to FIG. 4, the first dual band wireless communications unit 300 may include a first media access control (MAC) layer unit 310, a first physical layer unit 320, and a first dual band wireless communications unit 330.

The first MAC layer unit 310 may process transmission and reception data frame from the application processor 100 or data from the first physical layer unit 320.

The first physical layer unit 320 may be connected to the first MAC layer unit 310 and the first dual band wireless communications unit 330 and may include a first band physical layer unit 321 and a second band physical layer unit 322. The first band physical layer unit 321 may process modulation and demodulation, coding, and decoding on transmission and reception data for the first band and the second band physical layer unit 322 may process modulation and demodulation, coding, and decoding on transmission and reception data for the second band.

The first dual band wireless communications unit 330 may include a first band wireless communications unit 331 and a second band wireless communications unit 332 connected to the first band physical layer unit 321 and the second band physical layer unit 322, respectively. The first band wireless communications unit 331 may be connected to the first band physical layer unit 321 to perform wireless transmissions and reception through the first band, and the second band wireless communications unit 332 may be connected the second band physical layer unit 322 to perform wireless transmissions and reception through the second band.

The second dual band wireless communications unit 400 may include a second MAC layer unit 410, a second physical layer unit 420, and a second dual band wireless communications unit 430.

The second MAC layer unit 410 may process transmission and reception data frame from the application processor 100 or data from the second physical layer unit 420.

The second physical layer unit 420 may be connected to the second MAC layer unit 410 and the second dual band wireless communications unit 430 and may include a first band physical layer unit 421 and a second band physical layer unit 422. The first band physical layer unit 421 may process modulation and demodulation, coding, and decoding on transmission and reception data for the first band and the second band physical layer unit 422 may process modulation and demodulation, coding, and decoding on transmission and reception data for the second band.

The second dual band wireless communications unit 430 may include a first band wireless communications unit 431 and a second band wireless communications unit 432 connected to the first band physical layer unit 421 and the second band physical layer unit 422, respectively. The first band wireless communications unit 431 may be connected to the first band physical layer unit 421 to perform wireless transmissions and reception through the first band and the second band wireless communications unit 432 may be connected to the second band physical layer unit 422 to perform wireless transmissions and reception through the second band.

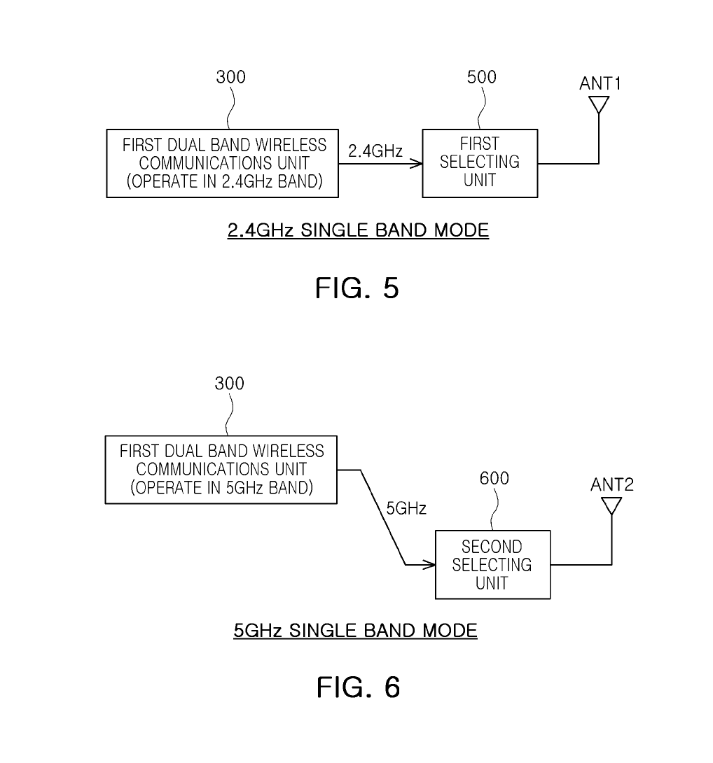

FIG. 5 is a first diagram of a single mode operation of the first dual band wireless communications unit according to an exemplary embodiment of the present disclosure and FIG. 6 is a second diagram of a single mode operation of the first dual band wireless communications unit according to an exemplary embodiment of the present disclosure.

Referring to FIGS. 5 and 6, when the connection to two connection target communications devices is not possible or a dual band connection of the connection target communications device is not possible, the application processor 100 may determine whether or not the MIMO operation is possible and may perform communications in a single mode using one of the first and second bands through the first dual band wireless communications unit 300 when the MIMO operation of the connection target communications device is not possible.

FIG. 5 illustrates an example in which the first dual band wireless communications unit 300 is operated in a single mode using the 2.4 GHz band of the 2.4 GHz band and the 5 GHz band and FIG. 6 illustrates an example in which the first dual band wireless communications unit 300 is operated in a single mode using the 5 GHz band of the 2.4 GHz band and the 5 GHz band.

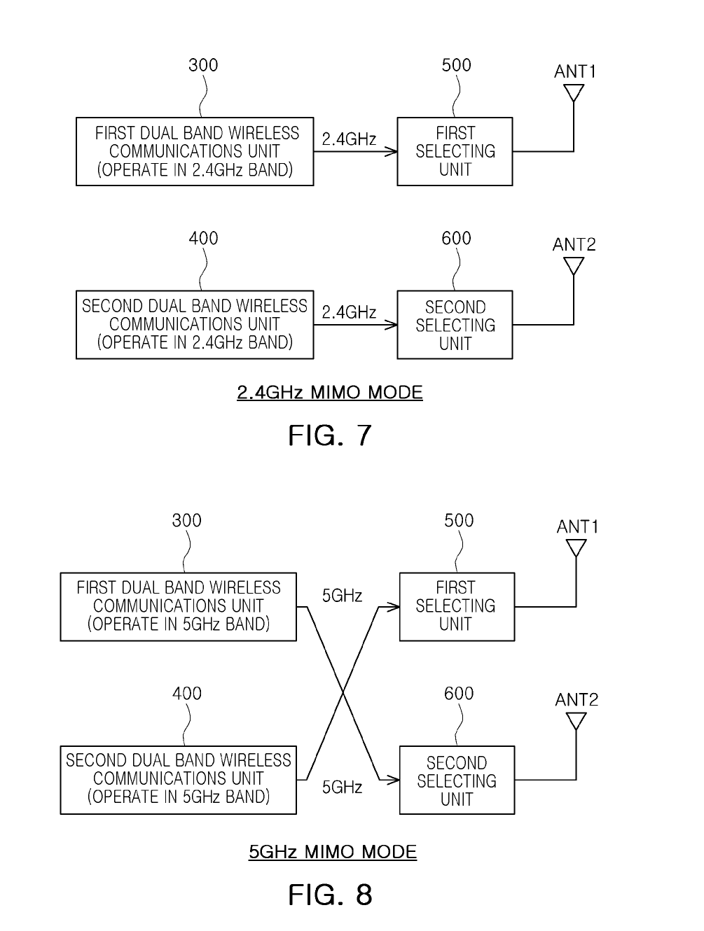

FIG. 7 is a first diagram of a MIMO operation of the first and second dual band wireless communications units according to an exemplary embodiment of the present disclosure and FIG. 8 is a second diagram of a MIMO operation of the first and second dual band wireless communications units according to an exemplary embodiment of the present disclosure.

Referring to FIGS. 7 and 8, when the connection to two connection target communications devices is not possible or a dual band connection of the connection target communications device is not possible, the application processor 100 may determine whether or not the MIMO operation is possible and may perform communications in a MIMO mode using one of the first and second bands through the first and second dual band wireless communications units 300 and 400 when the MIMO operation of the connection target communications device is possible.

FIG. 7 illustrates a communications example in which the first and second dual band wireless communications units 300 and 400 are operated in a MIMO mode using the 2.4 GHz band and FIG. 8 illustrates a communications example in which the first and second dual band wireless communications units 300 and 400 are operated in a MIMO mode using the 5 GHz band.

Here, in the case in which the first and second dual band wireless communications units 300 and 400 may perform the MIMO operation, a terminal needs to prepare a baseband signal processing for baseband MIMO operation and MIMO communications so that a concurrent signal processing is possible.

For example, as described above, in the case in which the channel information for the respective first and second antennas ANT1 and ANT2 is detected, the first and second dual band wireless communications units 300 and 400 are operated as a main IC (a primary main IC) and a sub IC (a secondary IC), respectively, to appropriately distribute and combine an original signal and transmit and receive the distributed and combined signal. This operation may be performed through a hardware control and a software control which may be suitably controlled by the application processor 100 and the interface unit 200.

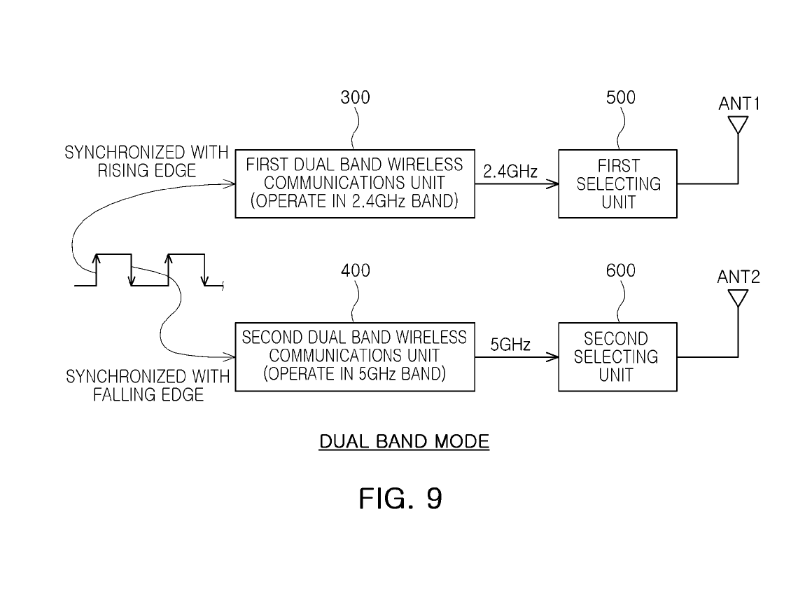

FIG. 9 is a diagram of a dual band mode operation of the first and second dual band wireless communications units according to an exemplary embodiment of the present disclosure.

Referring to FIG. 9, the application processor 100 may determine whether or not a dual band connection of the connection target communications device is possible and may perform communications using the first and second bands through the first and second dual band wireless communications units 300 and 400 when the dual band connection of the connection target communications device is possible.

For example, the application processor 100 may perform communications using the first and second bands through the first and second dual band wireless communications units 300 and 400.

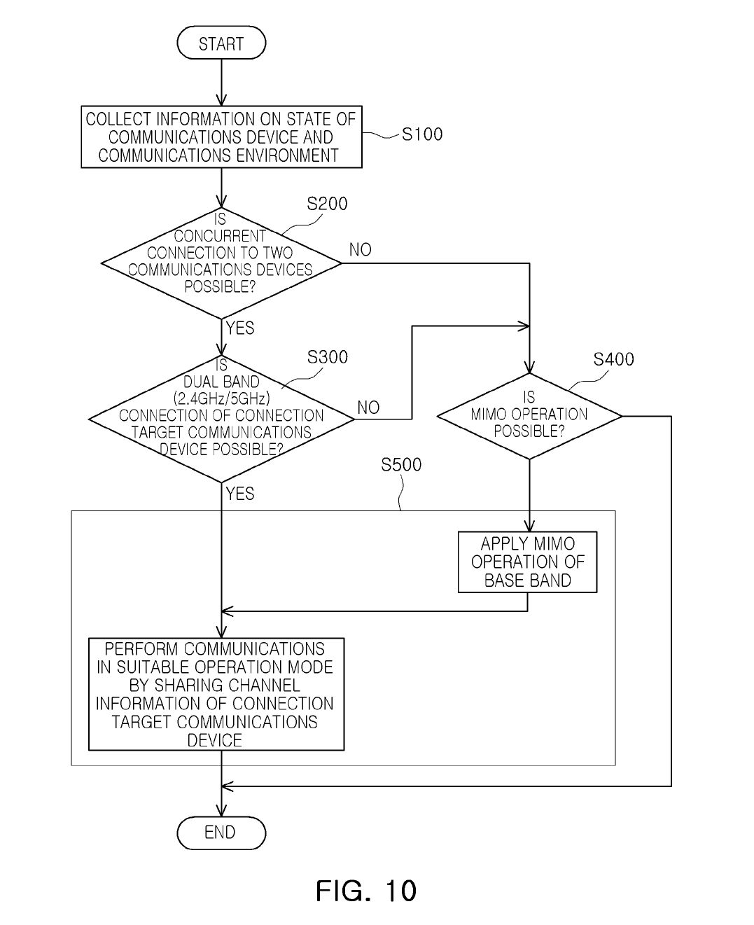

FIG. 10 is a flow chart showing an operating method of an adaptive dual band MIMO Wi-Fi apparatus according to an exemplary embodiment of the present disclosure.

An operating method of an adaptive dual band MIMO Wi-Fi apparatus according to an exemplary embodiment of the present disclosure will be described with reference to FIGS. 1 through 10.

Hereinafter, in describing an operating method of an adaptive dual band MIMO Wi-Fi apparatus according to an exemplary embodiment of the present disclosure, the description for the operations performed with reference to FIGS. 1 through 9 may be applied thereto. Therefore, an overlapped description in the case of a description of operating method of an adaptive dual band MIMO Wi-Fi apparatus will be omitted.

Referring to FIG. 10, in S100, an application processor 100 may collect information on a state of surrounding communications devices to communicate and a communications environment through a first dual band wireless communications unit 200.

Here, based on information in which the adaptive dual band MIMO Wi-Fi apparatus according to an exemplary embodiment of the present disclosure collects while performing WLAN communications with surrounding terminals and access points, it may be detected whether or not a concurrent connection to the two communications devices is possible, whether or not a dual band connection of the connection target communications device is possible, and whether or not an operation in the MIMO mode of the connection target communications device is possible.

In S200, the application processor 100 may determine whether or not the concurrent connection to the two communications devices is possible based on the collected information.

In S300, in the case in which the concurrent connection to the two communications devices is possible, the application processor 100 may determine whether or not the dual band connection of the connection target communications device is possible.

In S400, in the case in which the concurrent connection to the two communications devices is not possible or the dual band connection of the connection target communications device is not possible, the application processor 100 may determine whether or not the MIMO operation of the connection target communications device is possible.

In S500, the application processor 100 may share the channel information with the connection target communications device according to the determination result and may perform communications in one of a single mode, a dual mode, and a MIMO mode using at least one of the first and second dual band wireless communications units 300 and 400.

In S500 performing the communications, in the case in which the MIMO operation of the connection target communications device is not possible in S400 in which the application processor 100 determines whether or not the MIMO operation is possible, the application processor 100 may perform communications in the single mode using one of the first and second bands through the first dual band wireless communications unit 300.

In S500 performing the communications, in the case in which the MIMO operation of the connection target communications device is possible in S400 in which the application processor 100 determines whether or not the MIMO operation is possible, the application processor 100 may perform communications by using the MIMO operation using one of the first and second bands through the first and second dual band wireless communications units 300 and 400.

In S500 performing the communications, in the case in which the dual band connection of the connection target communications device is possible in S300 in which the application processor 100 determines whether or not the dual band connection of the connection target communications device is possible, the application processor 100 may perform communications using the first and second bands through the first and second dual band wireless communications units 300 and 400.

In S500 performing the communications, one of the 2.4 GHz band and the 5 GHz band, supported by the first dual band wireless communications unit 300 and one of the 2.4 GHz band and the 5 GHz band, supported by the second dual band wireless communications unit 400 may be used.

For example, in the case in which the adaptive dual band MIMO Wi-Fi apparatus according to an exemplary embodiment of the present disclosure performs communications in the dual band mode, the adaptive dual band MIMO Wi-Fi apparatus may receive Internet data using the 2.4 GHz band and may transmit video data to a smart TV using the 5 GHz band to view the smart TV.

In addition, when the adaptive dual band MIMO Wi-Fi apparatus according to an exemplary embodiment of the present disclosure is operated as a soft access point (soft AP), data may be received using the 2.4 GHz band while transmitting data using the 5 GHz band.

According to exemplary embodiments of the present disclosure, the dual band communications may be efficiently utilized and the MIMO operation may be performed even in the small portable apparatus.

While exemplary embodiments have been shown and described above, it will be apparent to those skilled in the art that modifications and variations could be made without departing from the spirit and scope of the present disclosure as defined by the appended claims.

What is claimed is:

1. An adaptive dual band Multiple-Input Multiple-Output (MIMO) wireless-fidelity (Wi-Fi) apparatus, comprising:
an application processor controlling wireless communications according to a service mode, determined depending on an communications environment and a state of a connection target communications device;
an interface unit transmitting data and a control signal from the application processor;
a first dual band wireless communications unit performing wireless communications using at least one of a first band and a second band according to controlling by the application processor;
a second dual band wireless communications unit operating of which is determined according to controlling by the application processor, performing wireless communications using at least one of the first band and the second band upon being operated;
a first selecting unit providing a first path between the first dual band wireless communications unit and a first antenna and providing a second path between the second dual band wireless communications unit and the first antenna; and
a second selecting unit providing a first path between the second dual band wireless communications unit and the second antenna and providing a second path between the first dual band wireless communications unit and the second antenna.

2. The adaptive dual band MIMO Wi-Fi apparatus of claim 1, wherein the application processor includes a clock generating unit generating a system clock signal, is synchronized with one of a rising edge and a falling edge of the system clock signal to control the first dual band wireless communications unit, and is synchronized with the other of the rising edge and the falling edge of the system clock signal to control the second dual band wireless communications unit.

3. The adaptive dual band MIMO Wi-Fi apparatus of claim 1, wherein the first selecting unit includes a diplexer low-passing a first band signal between the first dual band wireless communications unit and the first antenna and high-passing a second band signal between the second dual band wireless communications unit and the first antenna.

4. The adaptive dual band MIMO Wi-Fi apparatus of claim 1, wherein the second selecting unit includes a diplexer low-passing a first band signal between the second dual band wireless communications unit and the second antenna and high-passing a second band signal between the first dual band wireless communications unit and the second antenna.

5. An adaptive dual band Multiple-Input Multiple-Output (MIMO) wireless-fidelity (Wi-Fi) apparatus, comprising:
an application processor controlling wireless communications according to a service mode, determined depending on an communications environment and a state of a connection target communications device;
an interface unit transmitting data and a control signal from the application processor;
a first dual band wireless communications unit enabled to operate according to controlling by the application processor, operated by being synchronized with one of a rising edge and a falling edge of a preset system clock signal, and performing wireless communications using at least one of the first band and the second band;
a second dual band wireless communications unit enabled to operate according to controlling by the application processor, operated by being synchronized with the other of the rising edge and the falling edge of the system clock signal, and performing wireless communications using at least one of the first band and the second band;
a first selecting unit providing a first path between the first dual band wireless communications unit and a first antenna and providing a second path between the second dual band wireless communications unit and the first antenna; and
a second selecting unit providing a first path between the second dual band wireless communications unit and the second antenna and providing a second path between the first dual band wireless communications unit and the second antenna.

6. The adaptive dual band MIMO Wi-Fi apparatus of claim 5, wherein the application processor includes a clock generating unit generating the system clock signal, is synchronized with one of a rising edge and a falling edge of the system clock signal to control the first dual band wireless communications unit, and is synchronized with the other of the rising edge and the falling edge of the system clock signal to control the second dual band wireless communications unit.

7. The adaptive dual band MIMO Wi-Fi apparatus of claim 5, wherein the first dual band wireless communications unit includes:
a first media access control (MAC) layer unit processing transmission and reception data frames;
a first physical layer unit connected to the first MAC layer unit and including a first band physical layer unit processing modulation and demodulation, coding, and decoding for transmission and reception data for the first band and a second band physical layer unit processing modulation and demodulation, coding, and decoding for transmission and reception data for the second band; and
a first dual band wireless communications unit including a first band wireless communications unit connected to the first band physical layer unit and performing wireless transmissions and reception through the first band and a second band wireless communications unit connected to the second band physical layer unit and performing wireless transmissions and reception through the second band.

8. The adaptive dual band MIMO Wi-Fi apparatus of claim 5, wherein the second dual band wireless communications unit includes:
a second media access control (MAC) layer unit processing transmission and reception data frames;
a second physical layer unit connected to the second MAC layer unit and including a first band physical layer unit processing modulation and demodulation, coding, and decoding for transmission and reception data for the first band and a second band physical layer unit processing modulation and demodulation, coding, and decoding for transmission and reception data for the second band; and
a second dual band wireless communications unit including a first band wireless communications unit connected to the first band physical layer unit and performing wireless transmissions and reception through the first band and a second band wireless communications unit connected to the second band physical layer unit and performing wireless transmissions and reception through the second band.

9. The adaptive dual band MIMO Wi-Fi apparatus of claim 5, wherein the first selecting unit includes a diplexer low-passing a first band signal between the first dual band wireless communications unit and the first antenna and high-passing a second band signal between the second dual band wireless communications unit and the first antenna.

10. The adaptive dual band MIMO Wi-Fi apparatus of claim 5, wherein the second selecting unit includes a diplexer low-passing a first band signal between the second dual band wireless communications unit and the second antenna and high-passing a second band signal between the first dual band wireless communications unit and the second antenna.

11. An operating method of an adaptive dual band Multiple-Input Multiple-Output (MIMO) wireless-fidelity (Wi-Fi) apparatus, the method comprising:
collecting, by an application processor, information on surrounding communications device states for communication and a communications environment through a first dual band wireless communications unit;
determining, by the application processor, whether or not a concurrent connection to two communications devices is possible based on the collected information;
determining whether or not a dual band connection of a connection target communications device is possible when the concurrent connection to the two communications devices is possible;
determining whether or not a MIMO operation of the connection target communications device is possible when the concurrent connection to the two communications devices is not possible or the dual band connection of the connection target communications device is not possible; and
performing, by the application processor, communications in one of a single mode, a dual mode, and a MIMO mode using at least one of the first and second dual band wireless communications units by sharing channel information with the connection target communications device according the determination result.

12. The method of claim 11, wherein in the performing of the communications, when the MIMO operation of the connection target communications device is not possible in the determining of whether or not the MIMO operation is possible, the communications are performed in the single mode using one of first and second bands through the first dual band wireless communications unit.

13. The method of claim 11, wherein in the performing of the communications, when the MIMO operation of the connection target communications device is possible in the determining of whether or not the MIMO operation is possible, the communications are performed by using the MIMO operation using one of first and second bands through the first and second dual band wireless communications units.

14. The method of claim 11, wherein in the performing of the communications, when the dual band connection of the connection target communications device is possible in the determining of whether or not the dual band connection of the connection target communications device is possible, the communications are performed by using first and second bands through the first and second dual band wireless communications units.

15. The method of claim 11, wherein in the performing of the communications, one of the 2.4 GHz band and the 5 GHz band, supported by the first dual band wireless communications unit and one of the 2.4 GHz band and the 5 GHz band, supported by the second dual band wireless communications unit are used.

16. An operating method of an adaptive dual band Multiple-Input Multiple-Output (MIMO) wireless-fidelity (Wi-Fi) apparatus, the method comprising:
collecting, by an application processor, information on surrounding communications device states for communication and a communications environment through a first dual band wireless communications unit;
determining, by the application processor, whether or not a concurrent connection to two communications devices is possible based on the collected information;
determining whether or not a dual band connection of a connection target communications device is possible when the concurrent connection to the two communications devices is possible;
determining whether or not a MIMO operation of the connection target communications device is possible when the concurrent connection to the two communications devices is not possible or the dual band connection of the connection target communications device is not possible; and
performing, by the application processor, communications in one of a single mode, a dual mode, and a MIMO mode using at least one of the first and second dual band wireless communications units by sharing channel information with the connection target communications device according the determination result,
wherein when the application processor performs the communications in the dual mode, the first and second dual band wireless communications units are operated by being synchronized with different edges of a rising edge and a falling edge of a preset system clock signal.

17. The method of claim 16, wherein in the performing of the communications, when the MIMO operation of the connection target communications device is not possible in the determining of whether or not the MIMO operation is possible, the communications are performed in the single mode using one of first and second bands through the first dual band wireless communications unit.

18. The method of claim 16, wherein in the performing of the communications, when the MIMO operation of the connection target communications device is possible in the determining of whether or not the MIMO operation is possible, the communications are performed by using the MIMO operation using one of first and second bands through the first and second dual band wireless communications units.

19. The method of claim 16, wherein in the performing of the communications, when the dual band connection of the connection target communications device is possible in the determining of whether or not the dual band connection of the connection target communications device is possible, the communications are performed by concurrently using first and second bands through the first and second dual band wireless communications units.

20. The method of claim 16, wherein in the performing of the communications, one of a 2.4 GHz band and a 5 GHz band, supported by the first dual band wireless communications unit and one of a 2.4 GHz band and a 5 GHz band, supported by the second dual band wireless communications unit are used.
